(19) United States
(12) Patent Application Publication
(10) Pub. No.: US 2022/0083620 A1
(43) Pub. Date: Mar. 17, 2022

(54) SYSTEMS AND METHODS FOR RESTAURANT MENU DISCOVERY AND DISPLAY

(71) Applicant: GRIP PLACES, INC., Parker, CO (US)

(72) Inventors: Jon FAIRBAND, Parker, CO (US); Anthony HILDOER, Parker, CO (US)

(73) Assignee: GRIP PLACES, INC., Parker, CO (US)

(21) Appl. No.: 17/473,629

(22) Filed: Sep. 13, 2021

Related U.S. Application Data
(60) Provisional application No. 63/077,446, filed on Sep. 11, 2020.

(51) Int. Cl. G06F 16/955; G06F 3/0482; G06Q 50/12; G06K 7/14

(52) U.S. Cl. CPC G06F 16/9566; G06K 7/1417; G06Q 50/12; G06F 3/0482

(57) ABSTRACT

Methods, systems, and devices for accessing menus associated with a venue include receiving at a mobile computing device one of a QR code scan, a menu link selection, a user selection of a menu notification, or a URL entry while a user is at a venue. A determination as to whether a menu app is installed on the mobile computing device is then made. If the menu app is installed, the app determines whether there is a menu associated with the venue. If the menu app is not installed, a URL associated with the scanned QR code or the URL entry is opened on the mobile computing device. The systems and methods further include determining whether there is a menu associated with the venue available at the URL. If the menu is available, the menu is displayed with the mobile computing device.

### CROSS-REFERENCE TO RELATED APPLICATION

This application claims the benefit of and priority to U.S. Provisional Patent Application No. 63/077,446, filed Sep. 11, 2020, entitled SYSTEMS AND METHODS FOR RESTAURANT MENU DISCOVERY AND DISPLAY, the disclosure of which is incorporated herein by reference in its entirety.

### BACKGROUND

Restaurants typically provide menus for use by patrons to select and order food items. Digital menus are becoming increasingly popular because they provide advantages for patrons and restaurants. When a patron visits a restaurant, they may want to review a digital menu on their mobile device or elsewhere for reasons such as convenience, avoiding shared/dirty printed menus, enhanced multi-media experience, etc. Restaurant owners may want to provide digital menus to save on printing costs and maintenance associated with physical menus. Digital menus are also instantly updated, allowing for minute-to-minute changes, such as last-minute specials or promotions, or in the case of running out of stock of an item.

Some existing systems deliver digital menus at physical restaurants primarily using Quick Response (QR) codes. QR codes are physically posted at the restaurant in places where patrons can scan the code with their mobile device. The QR code is translated by the mobile device to a Uniform Resource Locator (URL), and either a website or Portable Document Format (PDF) file is accessible on the mobile device. The URL and QR code are unique to each restaurant location and are typically long and impractical for a human to remember or type into a mobile device. Further, the QR code must be scanned each time the patron visits a given venue. The menus accessed via QR code have a wide variety of quality, consistency, accuracy, and readability, particularly for different types of mobile devices.

Opportunities exist for improvements in the ways digital menus are discovered, accessed, and delivered for use. Such improvements may take advantage of advancements in computer systems and computer-related technologies.

### SUMMARY

The described techniques relate to improved methods, systems, devices, or apparatuses that provide, among other things, improvements to how menus are discovered, accessed, and delivered for use by consumers, such as patrons at a venue.

One aspect of the present disclosure relates to a method for accessing menus associated with a venue. The method includes receiving at a mobile computing device one of a QR code scan, a menu link selection, a user selection of a menu notification, or a URL entry while a user is at a venue, and determining with the mobile computing device whether a menu application (hereinafter “app”) is installed on the mobile computing device. If the menu app is installed, the method includes determining using the app whether there is a menu associated with the venue. If the menu app is not installed, the method includes opening with the mobile computing device a URL associated with the scanned QR code or the URL entry. The method further includes determining whether there is a menu associated with the venue available at the URL and displaying with the mobile computing device the menu associated with the venue if the menu is available.

If the menu app is not installed, the method may include determining with the mobile computing device a location of the venue and determining with the mobile computing device whether there is a menu associated with the venue available if the URL is based at least in part on the location. If the menu app is not installed, the method may include determining with the mobile computing device whether there is a menu associated with the venue available if the URL is based at least in part on a name of the venue. If the menu app is not installed, the method may include determining with the mobile computing device a location of the venue, determining a plurality of menus in proximity to the location, displaying information about the plurality of menus with the mobile computing device, receiving a menu selection from the user, and determining whether there is a menu associated with the selected venue.

When no menu is available, the method may include displaying with the mobile computing device a notice that a menu is not available. If the menu app is installed, the method may include determining with the mobile computing device a location of the venue and determining with the app whether there is a menu associated with the venue location. If the menu app is installed, the method may include determining with the mobile computing device a location of the user, determining with the app whether there is a menu associated with the user's location, and displaying with the mobile computing device a list of possible menus in proximity to the user's location.

The method may further include receiving a user selection of a menu from the list of possible menus and determining whether there is a menu available for the selected venue. If the menu app is installed, the method may include displaying a notice to the user on the mobile computing device that a menu is available for the venue.

Another aspect of the present disclosure relates to a method for accessing digital menus that includes detecting with a mobile computing device a user's location at a venue, identifying with the mobile computing device a menu associated with the venue, generating with the mobile computing device a menu notification, receiving at the mobile computing device a user selection associated with the menu notification, and displaying with the mobile computing device the menu associated with the venue.

A further aspect of the present disclosure relates to a method for accessing digital menus that includes detecting with a mobile computing device a user's location at a venue, generating with the mobile computing device a menu link notification, receiving at the mobile computing device a user selection associated with the menu link notification, and opening with the mobile computing device a URL associated with the venue link notification. The method further includes determining with the mobile computing device whether there is a menu associated with the venue at the URL, and displaying with the mobile computing device the menu associated with the venue if a menu associated with the venue is available at the URL, or displaying with the mobile computing device a notice that there is no menu available associated with the venue.

Another aspect relates to a method for accessing menus associated with a venue, including receiving at a mobile computing device a QR code scan while a user is at a venue, opening with the mobile computing device a URL associated with the scanned QR code, determining with the mobile computing device whether there is a menu associated with the venue at the URL, and displaying with the mobile computing device the menu associated with the venue if the menu associated with the venue is available. The method may also include displaying with the mobile computing device a notice that there is no menu available associated with the venue.

Another aspect relates to a method for accessing menus associated with a venue, including receiving at a mobile computing device a URL entry while a user is at a venue, opening with the mobile computing device the URL, determining with the mobile computing device whether there is a menu associated with the venue at the URL, and displaying with the mobile computing device the menu associated with the venue if the menu associated with the venue is available. The method may include displaying with the mobile computing device a notice that there is no menu available associated with the venue.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system that supports menu discovery, accessibility, and/or delivery in accordance with aspects of the present disclosure.

FIGS. 2A and 2B illustrate an example of a system architecture that supports menu discovery, accessibility, and/or delivery in accordance with aspects of the present disclosure.

FIGS. 3A and 3B illustrate additional aspects of the system architecture shown in FIGS. 2A and 2B in accordance with the present disclosure.

FIGS. 4-8 show flowcharts illustrating methods that support menu discovery, accessibility, and/or delivery, and other aspects of the present disclosure.

FIG. 9 shows a diagram of a system including a device that supports menu discovery, accessibility, and/or delivery, and other aspects of the present disclosure.

### DETAILED DESCRIPTION

The systems and methods disclosed herein relate to, among other things, the discovery, accessibility, and delivery of digital menus. Delivering digital menus to a user's mobile computing device (e.g., smart phone, tablet, or the like) is one aspect of the present disclosure. Another aspect of the present disclosure relates to a system that delivers menus in a much more user friendly way that minimizes user effort. The system may also substantially eliminate user effort to obtain digital menus once the app is installed (i.e., beyond removing their phone from their pocket).

One aspect relates to a system that uses a single, universal domain that is short and human readable and easily typable into a mobile browser. The use of such a single domain to access all menus associated with a plurality of participating venues may be one solution if the patron does not already have a custom app installed on her mobile device. If the patron does have the app installed on her mobile device, the patron need only open the app and the app will automatically display the menu associated with that venue. If the patron has a custom app installed, and arrives at a venue, the app will detect the location of the patron and automatically prompt the patron via her mobile device to view the menu on her mobile device.

Another aspect relates to how the menu is displayed for use by the patron. For example, the menu presented on the patron's mobile device may have a uniform layout, style, and appearance that is consistent between all restaurants. This allows the patron to quickly understand what the menu contains without having to learn a new layout.

Another aspect of the present disclosure relates to providing a relatively simple, in particular a single, act to access a digital menu regardless of the patron's location (e.g., different restaurant, club, bar, etc.). As such, a patron can more easily and reliably obtain a desired digital menu no matter what restaurant a user is sitting in by performing a simple act associated with her mobile device.

A further aspect relates to the use of QR codes to access a digital menu. The system may permit a patron to scan a QR code at a venue, and the QR code will point at the short domain mentioned above. Thus, patrons that do not already have the short domain memorized for entry into their mobile devices or their mobile devices do not already have the short domain stored for automatic use, and the mobile app is not active on the patrons' mobile devices, the system can automatically upgrade the mobile devices without any additional training by restaurant staff just by scanning the QR code. The menu simply displays the QR code, and the custom website will automatically train the patron and/or patron's mobile device. The system may also include automatic prompts for the patron to upgrade to the app, which will create an automatic menu delivery for the patron in the future based on sensed location, thus eliminating the patron's need to scan QR codes at venues in the future.

The system may include a feedback loop that informs a training algorithm as to which menu the user selected relative to their mobile computing device location. This allows the menu system to improve search results for future menu searches.

Many other aspects and details associated with the present disclosure are described with reference to the figures as described below. Reference to customer and user may be used interchangeably with patron or other terms identifying a person or living being that provides input into, is observed by, or is otherwise engaged with or focused on using the system and methods disclosed herein.

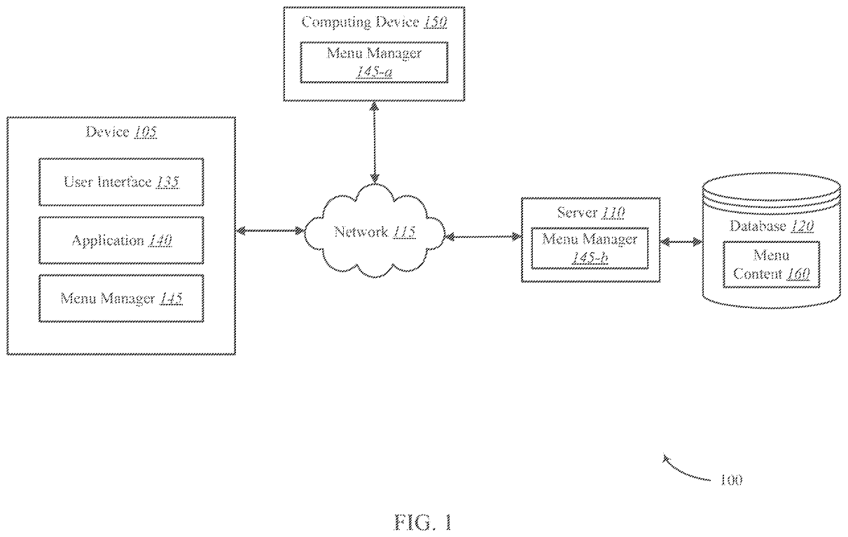

FIG. 1 illustrates a block diagram illustrating one example of a menu system 100 in which the present systems and methods may be implemented. In some examples, the systems and methods described herein may be performed on a device (e.g., the device 105). As depicted, the menu system 100 may include a device 105, a server 110, a network 115, and a computing device 110, and the menu system 100 enables the device 105, the server 110, and a database 120 to communicate with one another as described herein.

Examples of the device 105 may include any combination of, for example, mobile devices, smart phones, personal computing devices, computers, laptops, desktops, servers, media content set top boxes, or any combination thereof.

Examples of the computing device 110 may include at least one of one or more client machines, one or more mobile computing devices, one or more laptops, one or more desktops, one or more servers, one or more media set top boxes, or any combination thereof.

Examples of the server 110 may include, for example, a data server, a cloud server, proxy server, mail server, web server, application server, database server, communications server, file server, home server, mobile server, name server, or any combination thereof.

Although the database 120 is depicted as connecting to the device 105 via the network 115, in some examples, the device 105 may connect directly to the database 120. In some examples, the device 105 may connect or attach to at least one of the database 120 or the server 110 via a wired or wireless connection, or both. In some examples, the device 105 may attach to any combination of a port, socket, and slot of a separate computing device or the server 110.

In some configurations, the device 105 may include a user interface 135, an application 140, and a menu manager 145. Although the components of the device 105 are depicted as being internal to the device 105, it is understood that one or more of the components may be external to the device 105 and connect to the device 105 through wired or wireless connections, or both. Examples of the application 140 may include a web browser, a software application, a desktop application, a mobile application, etc. In some examples, the application 140 may be installed on a computing device in order to allow a user to interface with a function of the device 105, the server 110, the computing device 110, and the menu manager 145.

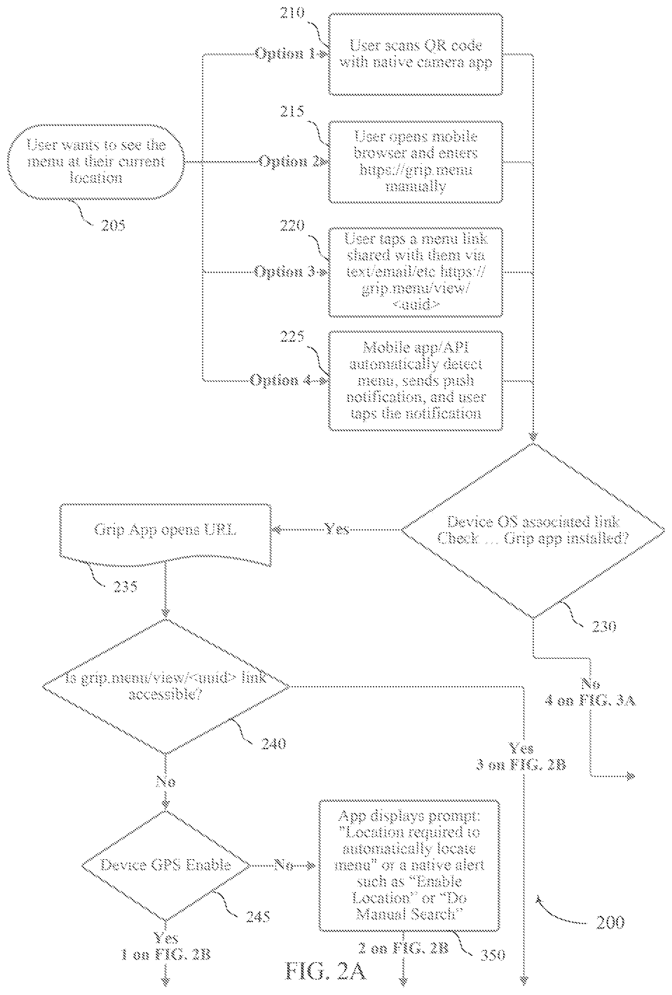

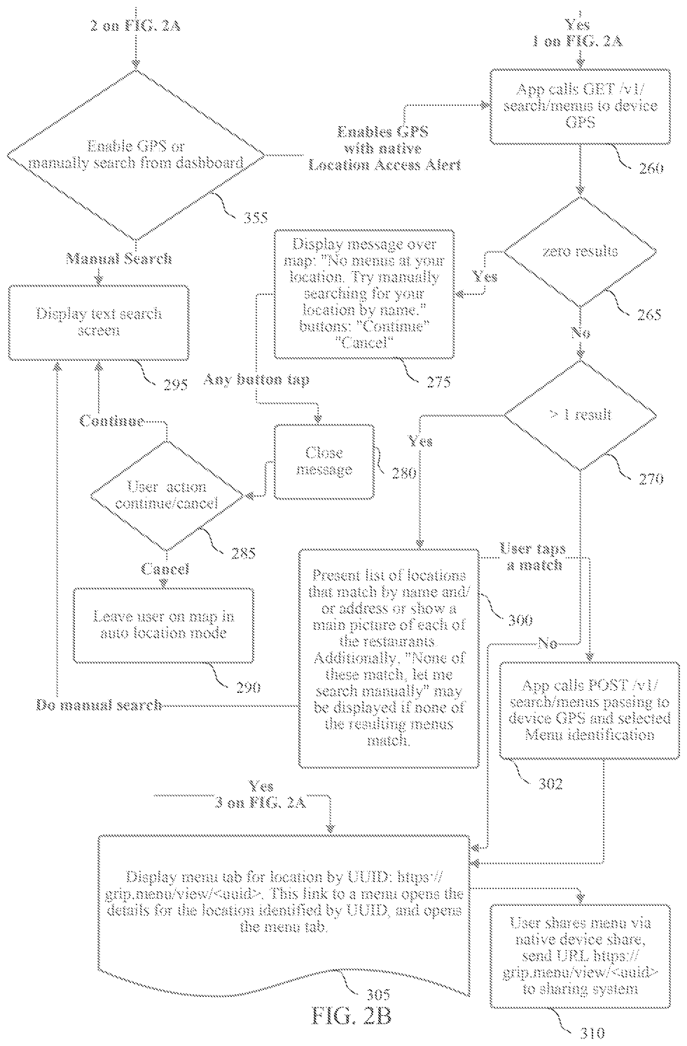

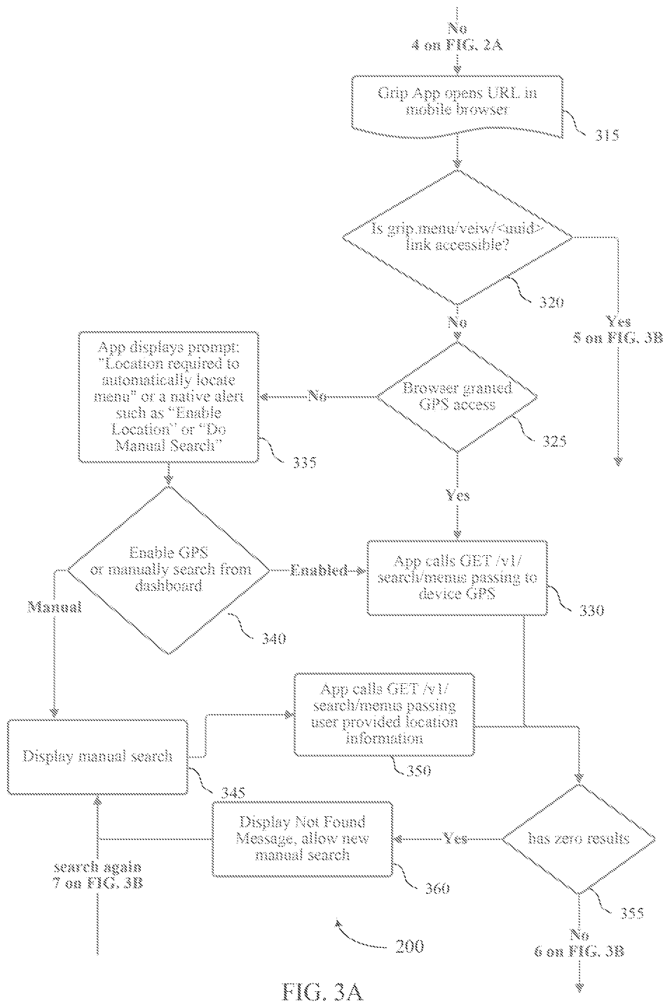

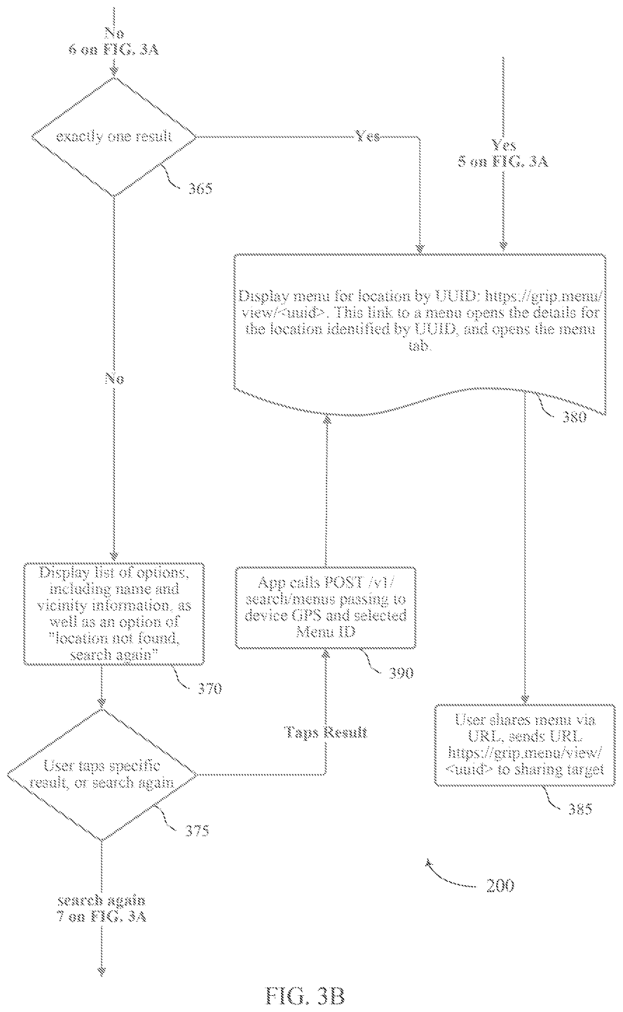

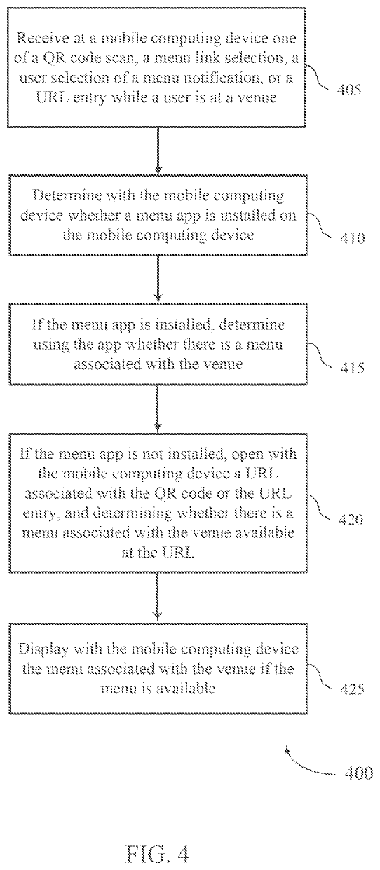

Although the device 105 is illustrated with an exemplary single application 140, in some examples the application 140 may represent two or more different applications installed on, running on, or associated with the device 105. In some examples, the application 140 may include one or more applications or programs. In some cases, the application 140 may include source code to operate one or more of the systems or system components described below with reference to FIGS. 2A-3B, or the method steps disclosed in FIGS. 4-8.

In some examples, the device 105 may communicate with the server 110 via the network 115. Examples of the network 115 may include any combination of cloud networks, local area networks (LAN), wide area networks (WAN), virtual private networks (VPN), wireless networks (using 802.11, for example), cellular networks (using a third generation network (3G), Long Term Evolution (LTE), or a fifth generation network (5G), for example), etc. In some configurations, the network 115 may include the Internet. In some examples, the device 105 may not include the menu manager 145. For example, the device 105 may include the application 140 that allows the device 105 to interface with a separate device via the menu manager 145 that is located on another device such as a separate computing device, the server 110, the database 120, and/or any combination thereof.

In some examples, at least one of the device 105, the database 120, and the server 110 may include the menu manager 145 where at least a portion of the functions of the menu manager 145 are performed separately and/or concurrently on the device 105, the database 120, and/or the server 110. In some examples, a user may access the functions of the device 105 (directly or through the device 105 via the menu manager 145) from the database 120 and/or the server 110. In some examples, the database 120 includes a mobile application that interfaces with one or more functions of the device 105, the server 110, and/or the menu manager 145.

In some examples, the server 110 may be coupled to the database 120. The database 120 may be internal or external to the server 110. In one example, the device 105 may be coupled to the database 120. In some examples, the database 120 may be internally or externally connected directly to the device 105. Additionally or alternatively, the database 120 may be internally or externally connected directly to the computing device 110 or one or more network devices such as a gateway, switch, router, intrusion detection system, etc. The database 120 may include the menu manager 145 or operate portions of menu manager 145. In some examples, the device 105 may access or operate aspects of the menu manager 145 from the database 120 over the network 115 via the server 110. The database 120 may include script code, hypertext markup language code, procedural computer programming code, compiled computer program code, object code, uncompiled computer program code, object-oriented program code, class-based programming code, cascading style sheets code, and/or any combination thereof.

In one example, the device 105 may be coupled to the database 120. In some examples, the database 120 may be internally or externally connected directly to the device 105. Additionally or alternatively, the database 120 may be internally or externally connected directly to one or more network devices such as a gateway, switch, router, intrusion detection system, etc.

The menu manager 145 may enable a variety of features and functionalities related to a menu. In some examples, the menu manager 145 may be configured to perform the systems and methods described herein in conjunction with the user interface 135 and the application 140. The user interface 135 may enable a user to interact with, control, or program one or more functions of the menu manager 145.

In some examples, the menu manager 145 enables discovery, accessibility, and/or delivery of a menu (e.g., a menu in a digital format that is viewable on a mobile computing device) associated with a particular venue. In some examples, the menu manager 145 may be part of or work in coordination with a custom app that is installed on a user's mobile communication device. Once the user has the custom app installed, the user will not have to scan another QR code at a venue or look up a menu while using that mobile computing device with the app installed. With the app functional on the user's mobile computing device (e.g., smart phone), the mobile computing device (via the app) will automatically notify the user of a digital menu when the user enters a venue.

The system 100 may include capability to automatically upgrade the user's device 105 who have become accustomed to the antiquated method of scanning a QR code every time they visit a venue, including when they re-visit the same venue over and over. If the user scans the QR code at any venue, the QR code will point to the URL https://grip.menu, the user will be shown a landing page in the browser of the user's mobile computing device. The landing page will show the existence of an app that will automatically deliver menus based on location. The site will also show the menu at the current location in the browser, with no need to install the app. However, if the user has the app installed, scanning the QR code opens the menu in the app directly.

Even without the app installed, accessing menus without a QR code may be relatively easy for a user by simply visiting the http://grip.menu URL in the user's mobile browser. By simply typing “grip.menu” into the browser it will display the menu if the user does not have the app installed on her mobile computing device or the mobile computing device will open the app and show her the menu associated with a venue at her location. The domain automatically discovers the Hypertext Transfer Protocol Secure (HTTPS) protocol, so the user has no need to type out the full HTTPS address. The simple “grip.menu” address is easy to remember and easy to type, unlike the URLs in existing QR codes of other systems.

The system can detect multiple menus in proximity, such as the case of a food court. The system can detect menus automatically for food trucks, that constantly move. If a user walks up to a food truck that just parked moments ago, grip.menu as well as the app will automatically discover the menu. Food trucks and other temporary or mobile establishments can install a tracking app and automatically broadcast the location of their business as they move, so users always get the menu even if the establishment moves throughout the day. In the case of mobile food services, like food trucks, users can search for a specific menu and find out where it is currently located.

The system may also include a feedback loop allowing a training system to learn what menus are relevant to a specific device location. The training may be part of a machine learning (ML) technique and may include artificial intelligence (AI). The training system may include one or more algorithms operable using the system, devices, and/or methods disclosed herein.

FIGS. 2A and 2B illustrates an example of a portion of a system architecture 200 that supports the menu related functionality in accordance with aspects of the present disclosure. In some examples, system architecture 200 may implement aspects of menu system 100. In the illustrated example, the system architecture 200 is an example of the underlying components, functions, and structure used to carry out one or more of the methods disclosed herein. Further aspects of the system architecture 200 are shown in FIGS. 3A and 3B and described below. The system 200 is exemplary of some or all of the inventive aspects of the present disclosure. Other example systems and methods are possible that include more steps, components, or other features than those illustrated in FIGS. 2A, 2B, 3A and 3B.

As shown, the system architecture 200 is initiated at 205 with a user wanting to see the menu at their current location. The user may be presented with several options. A first option, at 210, includes the user scanning a QR code with a native camera app on the user's mobile computing device. Option two, at 215, includes a user opening a mobile browser on their mobile computing device and manually entering a URL such as https://grip.menu. Option three, at 220, includes a user tapping a menu link shared with the user on their mobile computing device via, for example, text, email, etc. An example link may be https://grip.menu/view/. A fourth option, at 225, includes a mobile app/API operating on the user's mobile computing device automatically detecting a menu, sending a push notification to the user via the mobile computing device, and the user tapping/selecting an option from the notification.

At 230, the system 200 includes a step following one of the four options described above. At 230, the system 200 includes the device operating system associated link check to determine whether the mobile app (e.g., the grip app) is installed on the user's mobile computing device. If the app is installed, at 235 the system provides for the app to open a URL to search for the menu associated with a venue at the user's current location. At 240, the system 200 determines whether the URL (e.g., grip.menu/view) is accessible. If that URL is accessible, the system moves to 305 described below. If the link is not accessible, the system moves to 245 wherein the mobile computing device confirms whether its Global Positioning System (GPS) is enabled. If the GPS is not enabled, at 350 the system 200 has the app display a prompt on the user's mobile computing device such as, for example, “location required to automatically locate menu.” This message can be a native alert with “enable location,” or “do manual search,” or related message for prompting the user to take further action. At 355, the system 200 provides options to enable GPS or manually search from a dashboard on the user's mobile computing device. If GPS is enabled with a native location access alert or the like, at 260 the system 200 provides the app calling GET/view1/search/menus (passing in device GPS) or the like.

If the manual search is required, at 295, the system takes the user to a text search screen such as if the user had tapped/selected the magnifier on the dashboard of the mobile computing device. The user may then conduct a manual search, for example, for a venue associated with the user's location.

If GPS is enabled and a search for menus has been conducted based on location at 260, at 265 a determination is made whether there are zero results. If there are not zero results, at 270 a determination is made whether there is more than one result. If there are zero results, at 275 a message is displayed over, for example, a map such as “No menus at your location. Try manually searching for your location by name.” Further, the user may be presented with options of “continue” or “cancel” at the mobile computing device. If either option is selected by, for example, selecting either option, at 280 the message is closed. A user action to continue or cancel at 285 is determined using the app. If continue is selected, the system 200 moves to 295 wherein the user is taken to a text search screen as described above. If the user selects cancel at 285, the system 200 moves to 290 wherein the user is left on a map screen on the mobile computing device in auto location mode.

If the search has generated more than one result, at 300 the user may be presented with a list of locations that match by name and/or address. Other options include showing the main picture of the restaurant or other venue identifying information. A further option would be for the user to select “none of these match, let me search manually,” or something similar if none of the resulting venues match their venue. In the event that there is not a match, the system may direct the user back to 295 wherein a manual search may be conducted on the mobile computing device.

If the user selects a match from the list of locations at 300, at 305 a menu tab may be displayed on the user's mobile computing device for location by, for example, UUID: https://grip.menu/view, or related URL. This link to a menu opens the details for the location identified by UUID and opens the menu tab. At 310, the user may share the menu via native device share to send a URL (e.g., https://grip.menu/view/) to a sharing system.

The system 200 may include a feedback loop in the portion of the system shown in FIGS. 2A and 2B that informs a training algorithm as to which menu the user selected from the list of options at 300 relative to the location of their mobile computing device. This allows the system 200 to improve search results for future menu searches. The training algorithm may include machine learning tools and/or techniques and may employ artificial intelligence (AI) features and functionality. At 302, the system 200 may include the app calling POST/v1/search/menus as a passing in the mobile computing device's GPS and selected menu identification.

Referring now to FIGS. 3A and 3B, after one of the options at 210-225 and an app is not identified on the user's mobile computing device at 230, the system 200 may direct the user to 315 wherein a URL is opened on a browser of the user's mobile computing device. The system 200 determines if the URL is associated with a specific URL such as grip.menu/viewer/link at 320. If the link is accessible, the system directs to 380, which will be described below. If the link is not accessible, the system 200 moves to 325 wherein a browser is granted GPS access. If GPS access is granted, at 330 the app calls GET/v1/search/menus (passing in device GPS). If GPS access is not available, at 335 the app displays a prompt such as: “Location required to automatically locate menu,” or something similar. This can be a native alert with “enable location,” or “do manual search,” or something similar.

The system may then move to 340 wherein, for example, options, enable GPS, or manual search from dashboard is determined. If GPS is enabled, the system directs to 330. If it is not enabled and a manual search is required, the system directs to 345, wherein a manual search field is displayed on the user's mobile computing device. The system may then direct to 350 wherein an app calls GET/v1/search/menus (passing user provided location information), or the like.

The system 200 determines whether zero results from the GPS based search at 355. If there are zero results, the system directs to 360 wherein a display of not found message occurs and allowing new manual search. If there are not zero results, the system directs to 365, wherein a determination is made whether there is exactly one search result. If there is one search result, the system directs to 380 and the menu is displayed on the user's mobile computing device for location by, for example, UUID: https://grip.menu/view/. This link to a menu may open the details for the menu of a venue at the user's location as identified by UUID and opens the menu tab for viewing by the user on their mobile computing device. At 385, the user may share the menu via, for example, URL, send URL https://grip.menu/view/to a sharing target.

If there is more than one result from the search, the system directs to 370 wherein a list of options is displayed on the user's mobile computing device. The list may include name and vicinity information and/or an option of “location not found, search again.” At 375, the user may have the option of selecting a specific option from the list or searching again. If choosing to search again, the system directs to 345 wherein a manual search window is displayed. If the user selects an option from the list, the system directs to 380 as described above.

The system 200 may include a feedback loop in the portion of the system shown in FIGS. 3A and 3B that informs a training algorithm as to which menu the user selected from the list of options at 300 relative to the location of their mobile computing device. This allows the system 200 to improve search results for future menu searches. The training algorithm may include machine learning tools and/or techniques and may employ artificial intelligence (AI) features and functionality. At 390, the system 200 may include the app calling POST/v1/search/menus as a passing in the mobile computing device's GPS and selected menu ID.

FIG. 4 shows a flow chart illustrating a method 400 for discovering, accessing and/or displaying menus in accordance with aspects of the present disclosure. The operations of the method 400 may be implemented by a device or its components as described herein. For example, the operation of the method 400 may be performed by a menu manager as described with reference to FIG. 1. The menu manager described with reference to FIG. 1 may operate to perform some or all of the functions associated with the system 200 described with reference to FIGS. 2A, 2B, 3A, and 3B. In some examples, a device may execute a set of instructions to control the functional elements of the device to perform the functions described herein. Additionally or alternatively, a device may perform aspects of the functions described herein using special purpose hardware.

At 405, the method 400 includes receiving at a mobile computing device one of a QR code scan, a menu link selection, a user selection of a menu notification, or a URL entry while user is at a venue or other location. At 410, the method 400 includes determining with the mobile computing device whether a menu app is installed on the mobile computing device. At 415, if the menu app is installed, the method 400 includes determining using the app whether there is a menu associated with the venue or other location. At 420, if the menu app is not installed, the method 400 includes opening with the mobile computing device a URL associated with the QR code or the URL entry, in determining whether there is a menu associated with the venue available at the URL. At 425, the method 400 includes displaying with the mobile computing device the menu associated with the venue if the menu is available.

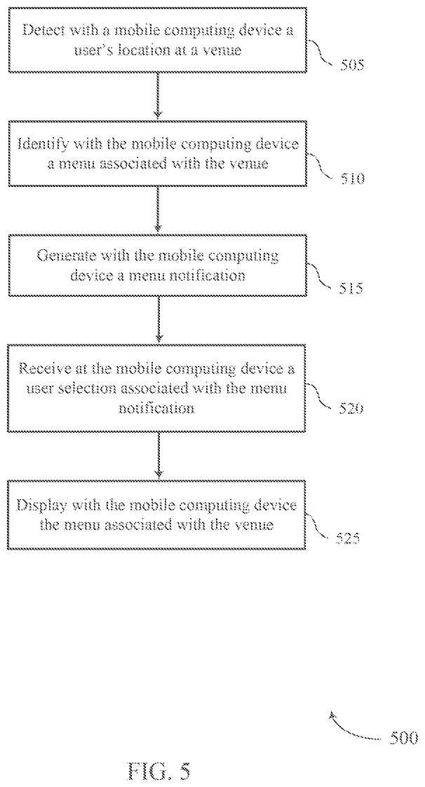

FIG. 5 shows a flow chart illustrating a method 500 for discovering, accessing and/or displaying menus in accordance with aspects of the present disclosure. The operations of the method 500 may be implemented by a device or its components as described herein. For example, the operation of the method 500 may be performed by a menu manager as described with reference to FIG. 1. The menu manager described with reference to FIG. 1 may operate to perform some or all of the functions associated with the system 200 described with reference to FIGS. 2A, 2B, 3A, and 3B. In some examples, a device may execute a set of instructions to control the functional elements of the device to perform the functions described herein. Additionally or alternatively, a device may perform aspects of the functions described herein using special purpose hardware.

At 505, the method 500 includes detecting with a mobile computing device a user's location at a venue. At 510, the method includes identifying with a mobile computing device a menu associated with the venue. The method 500 includes, at 515, generating with the mobile computing device a menu notification. At 520, the method 500 includes receiving at the mobile computing device a user selection associated with the menu notification. At 525, the method includes displaying with the mobile computing device the menu associated with the venue.

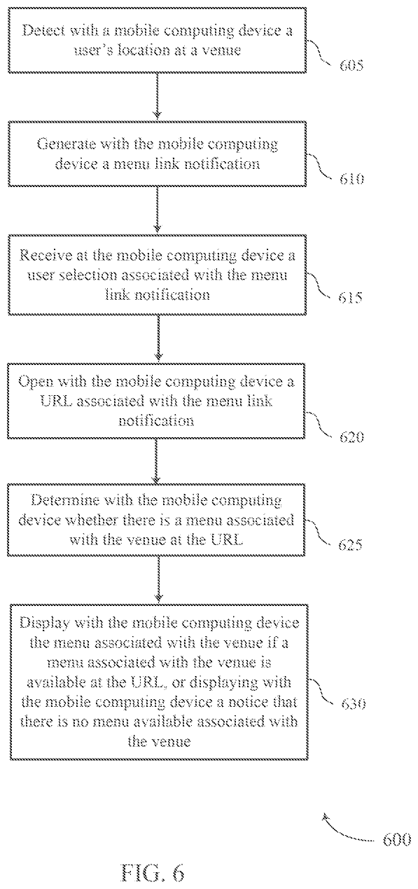

FIG. 6 shows a flow chart illustrating a method 600 for discovering, accessing and/or displaying menus in accordance with aspects of the present disclosure. The operations of the method 600 may be implemented by a device or its components as described herein. For example, the operation of the method 600 may be performed by a menu manager as described with reference to FIG. 1. The menu manager described with reference to FIG. 1 may operate to perform some or all of the functions associated with the system 200 described with reference to FIGS. 2A, 2B, 3A, and 3B. In some examples, a device may execute a set of instructions to control the functional elements of the device to perform the functions described herein. Additionally or alternatively, a device may perform aspects of the functions described herein using special purpose hardware.

At 605, the method 600 includes detecting with a mobile computing device a user's location at a venue. At 610, the method includes generating with the mobile computing device a menu link notification. The method 600 includes, at 615, receiving at the mobile computing device a user selection associated with the menu link notification. At 620, the method includes opening with the mobile computing device a URL associated with the menu link notification. The method includes, at 625, determining with the mobile computing device whether there is a menu associated with the venue at the URL. At 630, the method includes displaying with the mobile computing device the menu associated with the venue if a menu associated with the venue is available at the URL. Alternatively, the method 600 includes displaying with the mobile computing device a notice that there is no menu available associated with the venue.

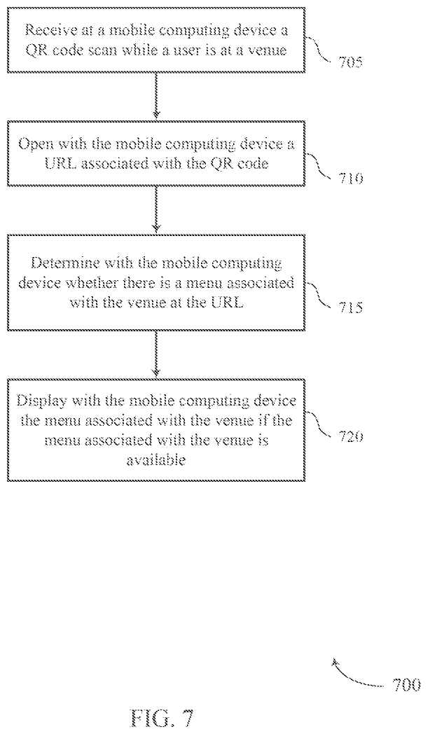

FIG. 7 shows a flow chart illustrating a method 700 for discovering, accessing and/or displaying menus in accordance with aspects of the present disclosure. The operations of the method 700 may be implemented by a device or its components as described herein. For example, the operation of the method 700 may be performed by a menu manager as described with reference to FIG. 1. The menu manager described with reference to FIG. 1 may operate to perform some or all of the functions associated with the system 200 described with reference to FIGS. 2A, 2B, 3A, and 3B. In some examples, a device may execute a set of instructions to control the functional elements of the device to perform the functions described herein. Additionally or alternatively, a device may perform aspects of the functions described herein using special purpose hardware.

At 705, the method 700 includes receiving at a mobile computing device a QR code scan while a user is at a venue. At 710, the method includes opening with a mobile computing device a URL associated with the QR code. The method includes, at 715, determining with the mobile computing device whether there is a menu associated with the venue at the URL. At 720, the method includes displaying with the mobile computing device the menu associated with the venue if the menu associated with the venue is available.

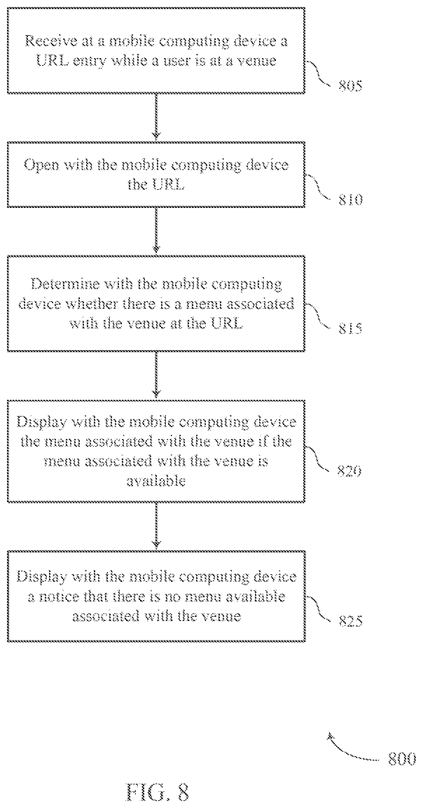

FIG. 8 shows a flow chart illustrating a method 800 for discovering, accessing and/or displaying menus in accordance with aspects of the present disclosure. The operations of the method 800 may be implemented by a device or its components as described herein. For example, the operation of the method 800 may be performed by a menu manager as described with reference to FIG. 1. The menu manager described with reference to FIG. 1 may operate to perform some or all of the functions associated with the system 200 described with reference to FIGS. 2A, 2B, 3A, and 3B. In some examples, a device may execute a set of instructions to control the functional elements of the device to perform the functions described herein. Additionally or alternatively, a device may perform aspects of the functions described herein using special purpose hardware.

At 805, the method 800 includes receiving at a mobile computing device a URL entry while a user is at a venue. At 810, the method 800 includes opening with the mobile computing device the URL. At 815, the method includes determining with the mobile computing device whether there is a menu associated with the venue at the URL. The method 800 includes, at 820, displaying with the mobile computing device the menu associated with the venue if the menu associated with the venue is available. At 825, the method includes displaying with the mobile computing device a notice that there is no menu available associated with the venue.

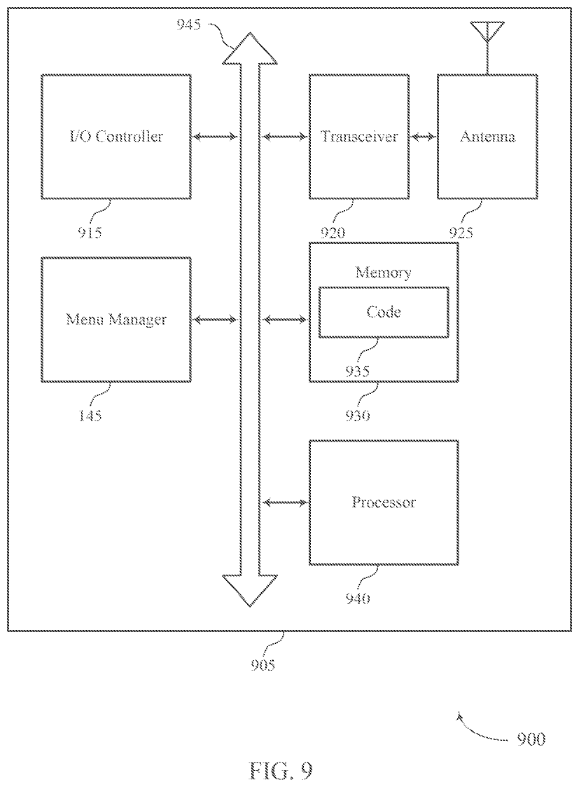

FIG. 9 shows a diagram of a system 900 including a device 905 that supports discovering, accessing and/or displaying a menu associated with a venue in accordance with aspects of the present disclosure. The device 905 may be an example of or include the components of the device 105 or a device as described herein. The device 905 may include components for bi-directional voice and data communications including components for transmitting and receiving communications, including a menu manager 145, an I/O controller 915, a transceiver 920, an antenna 925, memory 930, a processor 940, and a coding manager 935. These components may be in electronic communication via one or more buses (e.g., bus 945).

The menu manager 145 may provide any combination of the operations and functions described above related to the system architecture 200 and the methods 400, 500.

The I/O controller 915 may manage input and output signals for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a Digital Signal Processing (DSP), a Central Processing Unit (CPU), a microcontroller, an application-specific integrated circuit (ASIC), an field programmable gate array (FPGA), a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting menu related functions and other functions associated with the systems and methods disclosed herein).

The code 935 may include instructions to implement aspects of the present disclosure, including instructions to support dynamic accessibility compliance of a website. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, menu system 100 and/or the system architecture 200 of FIGS. 1, 2A, 2B, 3A, and 3B, respectively—may include one or more carriers.

The systems and methods disclosed herein may provide a number of advantages, such as the following: (1) providing a short domain name that is easy to remember and type into a mobile computing device browser, and eliminate need for QR codes at venues; (2) using a single app and website for all restaurants everywhere such that there is no need to have multiple URLs, QR codes or apps installed on a user's mobile computing device; (3) dynamic menu locations for food trucks or other mobile food providers; (4) finding moving menus, such as food trucks; (5) automatic upgrade of the system using only a smart phone or other mobile computing device; and (6) push notifications within the mobile app to prompt the user to open a menu the moment she arrives at a venue.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical venues. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for accessing menus associated with a venue, comprising:
receiving at a mobile computing device one of a Quick Response (“QR”) code scan, a menu link selection, a user selection of a menu notification, and a Uniform Resource Locator (“URL”) entry while a user is at a venue;
determining with the mobile computing device whether a menu app is installed on the mobile computing device;
if the menu app is installed, determining using the app whether there is a menu associated with the venue;
if the menu app is not installed, opening with the mobile computing device a URL associated with the scanned QR code or the URL entry, and determining whether there is a menu associated with the venue available at the URL; and
displaying with the mobile computing device the menu associated with the venue if the menu is available.

2. The method of claim 1, further comprising:
if the menu app is not installed, determining with the mobile computing device a location of the venue; and
determining with the mobile computing device whether there is a menu associated with the venue available if the URL is based at least in part on the location.

3. The method of claim 2, wherein:
if the menu app is not installed, determining with the mobile computing device whether there is a menu associated with the venue available if the URL is based at least in part on a name of the venue.

4. The method of claim 2, further comprising:
if the menu app is not installed, determining with the mobile computing device a location of the venue;
determining a plurality of menus in proximity to the location;
displaying information about the plurality of menus with the mobile computing device;
receiving a menu selection from the user; and
determining whether there is a menu associated with the selected venue.

5. The method of claim 1, wherein:
when no menu is available, displaying with the mobile computing device a notice that a menu is not available.

6. The method of claim 1, wherein:
if the menu app is installed, determining with the mobile computing device a location of the venue; and
determining with the app whether there is a menu associated with the venue location.

7. The method of claim 1, wherein:
if the menu app is installed, determining with the mobile computing device a location of the user;
determining with the app whether there is a menu associated with the user's location; and
displaying with the mobile computing device a list of possible menus in proximity to the user's location.

8. The method of claim 7, further comprising:
receiving a user selection of a menu from the list of possible menus; and
determining whether there is a menu available for the selected venue.

9. The method of claim 1, further comprising:
if the menu app is installed, displaying a notice to the user on the mobile computing device that a menu is available for the venue.

10. A method for accessing digital menus, comprising:
detecting with a mobile computing device a user's location at a venue;
identifying with the mobile computing device a menu associated with the venue;
generating with the mobile computing device a menu notification;
receiving at the mobile computing device a user selection associated with the menu notification; and
displaying with the mobile computing device the menu associated with the venue.

11. The method of claim 10, further comprising:
determining with the mobile computing device whether a menu app is installed on the mobile computing device.

12. The method of claim 11, further comprising:
if the menu app is not installed, determining with the mobile computing device a location of the venue; and
determining with the mobile computing device whether there is a menu associated with the venue available if a Uniform Resource Locator (“URL”) is based at least in part on the location.

13. The method of claim 12, wherein:
if the menu app is not installed, determining with the mobile computing device whether there is a menu associated with the venue available if the URL is based at least in part on a name of the venue.

14. The method of claim 12, further comprising:
if the menu app is not installed, determining with the mobile computing device a location of the venue;
determining a plurality of menus in proximity to the location;
displaying information about the plurality of menus with the mobile computing device;
receiving a menu selection from the user; and
determining whether there is a menu associated with the selected venue.

15. The method of claim 11, wherein:
when no menu is available, displaying with the mobile computing device a notice that a menu is not available.

16. The method of claim 11, wherein:
if the menu app is installed, determining with the mobile computing device a location of the venue; and
determining with the app whether there is a menu associated with the venue location

17. A method for accessing menus associated with a venue, comprising:
receiving at a mobile computing device a Quick Response (“QR”) code scan while a user is at a venue;
opening with the mobile computing device a Uniform Resource Locator (“URL”) associated with the scanned QR code;
determining with the mobile computing device whether there is a menu associated with the venue at the URL; and
displaying with the mobile computing device the menu associated with the venue if the menu associated with the venue is available.

18. The method of claim 17, further comprising:
displaying with the mobile computing device a notice that there is no menu available associated with the venue.

19. The method of claim 17, further comprising:
determining with the mobile computing device whether a menu app is installed on the mobile computing device.

20. The method of claim 19, further comprising:
if the menu app is not installed, determining with the mobile computing device a location of the venue; and
determining with the mobile computing device whether there is a menu associated with the venue available if the URL is based at least in part on the location.
